(19) United States
(12) Patent Application Publication
(10) Pub. No.: US 2003/0101368 A1
(43) Pub. Date: May 29, 2003

(54) System and method for detecting and handling communication based errors in a wireless transaction system

(76) Inventors: Alan L. Swain, Richmond (CA); Kevin K. M. Woo, Surrey (CA)

Correspondence Address: Fasken Martineau DuMoulin LLP, Toronto-Dominion Centre, Toronto Dominion Bank Tower, Suite 2400, Box 20, Toronto, ON, M5K 1N6, CA

(21) Appl. No.: 10/032,390

(22) Filed: Dec. 31, 2001

(30) Foreign Application Priority Data
Dec. 29, 2000 (CA) 2,330,017

(51) Int. Cl. G06F 11/00

(52) U.S. Cl. 714/4

(57) ABSTRACT

A data processing method for handling of errors in communication between a wireless device and a server in a wireless transaction processing system, the method comprising the steps of creating, within persistent storage, a transaction log containing recovery information which can be used for recovery from errors in communication during a transaction; determining whether error correction information received from said wireless meets at least one predetermined criterion; and performing an error handling process if the received error correction information meets the predetermined criterion.

The present application claims priority from Canadian patent application No. 2,330,017. The present invention relates to the field of wireless electronic transaction systems, and more particularly to a method for accurately reflecting states between a wireless client and server, where an extension of the server-side state is held within a wireless device in volatile memory.

### BACKGROUND OF THE INVENTION

Point of sale (POS) systems have become almost universally adopted by merchants. While most POS systems are deployed at a merchant's premises, a wireless POS system has mobile terminals that allows electronic payment to be made other than at the merchant premises. This has created new business opportunities for existing merchants, while spawning new business ventures. For example, Internet shopping with “payment at the door” opens new marketing channels with increased sales. We are all familiar with the delivery of groceries, pizza and other food stuffs ordered from a vendor by telephone or the Internet and delivered to the customer's home where payment by, credit or debit card is approved using a remote handheld POS terminal.

A wireless POS system typically comprises one or more wireless POS terminals connected via a wireless network through a gateway to a financial transaction server (FTS), which is typically the merchant's bank or processor operating on behalf of the merchant's bank, often referred to as the acquiring bank. One of the benefits of these wireless POS systems is that the customer is not always required to have cash on hand. Further, the POS system is normally integrated with the merchant's payment transaction server and allows various electronic reconciliation of the merchant's bank account with that of the financial institution (FI) and reduces the amount of paperwork for the merchant.

One of the disadvantages, however, of the traditional wireless POS terminal is that it is relatively expensive, runs a proprietary protocol and has to be obtained from one of a limited number of suppliers. These special POS terminals were developed out of necessity to ensure reliable and trusted communication between the POS terminal and the FTS and more importantly, to provide the customer with a degree of confidence that the exchange has been transacted with a legitimate merchant.

One solution in order to lower the cost of traditional POS systems is to utilize, instead of dedicated POS terminals, the use of inexpensive wireless devices, such as cellular telephones, PDAs and similar personal trusted devices. Some of the benefits of such devices are that they are inexpensive and are capable of operating over the relatively inexpensive wireless Internet infrastructure. Typically, these devices communicate using an open global standard for wireless Internet transmission such as the Wireless Application Protocol (WAP).

WAP devices include a WAP microbrowser to interact with server-side WAP/Web applications. The HTTP protocol is used for passing data in the form of pages between the microbrowser on the wireless device and the Web application. The stateless nature of Hyper-Text Transfer Protocol (HTTP) is a disadvantage of any web application that runs on a server computer connected to a network and which uses HTTP to communicate with client web browsers. This is because the HTTP protocol is generally a stateless request/response protocol. That is, for every request generated by a user, the web application provides a response, which typically includes one or more variables used by the application to identify the user and/or the session.

WAP/Web applications basically follow a client/server communications model in which the client (microbrowser) is not required to maintain state information. The state is typically held within the server-side business logic of an application server. This ‘statelessness’ of the microbrowser within wireless devices poses a problem for some applications as for example in financial transactions like POS transactions. POS transactions tend to require a sequence of steps or states at the server before the transaction is completed. For example, in a wireless cash transaction, the user sends a request to a merchant payment application running on the webserver, which in turn forwards the request to a FI for approval. The response from the FI is sent to the payment application, which in turn forwards the response to the user. Thus the server state needs to be accurately reflected to the user of the POS device to avoid any out of balance conditions between the user, merchant and the FI.

Consequently there is a need for the server to detect duplicate messages from a mobile device or detect a possible undelivered message from a mobile device. Furthermore in the case of incomplete transactions there is a need to implement reversals to avoid, in the specific case of financial transactions, out of balance situations at the FI or processor.

### SUMMARY OF TAE INVENTION

The present invention seeks to provide a solution to the problem of extending a server-side state machine to stateless microbrowser based devices over inherently unstable wireless networks.

In accordance with this invention there is provided a data processing method for handling of errors in communication between a wireless device and a server in a wireless transaction processing system, the method comprising the steps of:

creating, within persistent storage, a transaction log containing recovery information, which can be used for recovery from errors in communication during a transaction;

retrieving, from the transaction log, said recovery information relating to a current transaction;

comparing said retrieved information to error correction information received from said wireless device;

determining whether the received error correction information meets at least one predetermined criterion; and

performing an error handling process if the received error correction information meets the predetermined criterion.

An advantage of the present system is the ability to detect duplicate messages from a wireless device.

A further advantage is the ability to detect a possible undelivered message from a wireless device.

A still further advantage is the ability, in the case of incomplete transactions, to implement error recovery, such as reversals to avoid, in the specific case of financial transactions, out of balance situations at the FI or processor.

### BRIEF DESCRIPTION OF THE DRAWINGS

FIG. 1 is a schematic diagram of a wireless transaction system according to an embodiment of the invention;

FIG. 2 is a flow diagram showing an error detection process according to an embodiment of the present invention; and

FIGS. 3, 4 and 5 are ladder diagrams showing a message exchange sequence in the system of FIG. 1.

### DETAILED DESCRIPTION OF THE PREFERRED EMBODIMENTS

In the following, like numerals refer to like structures in the drawings.

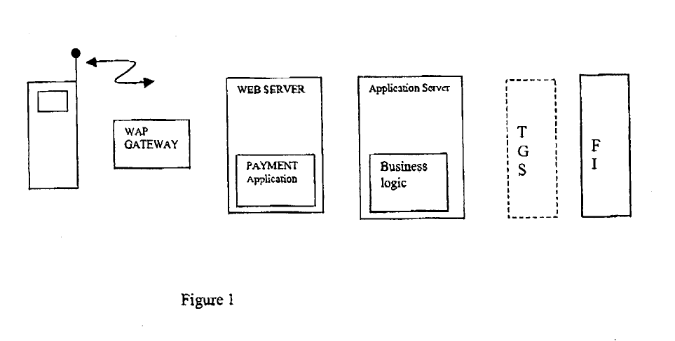

Referring to FIG. 1, there is illustrated a general representation of the manner for using a personal trusted device (PTD) such as a mobile terminal in wireless transaction system according to an embodiment of the present invention. The system 100 preferably includes at least one WAP (or some other type of mobile internet protocol) enabled device 110 such as a cell phone, alternatively, the PTD could be a laptop computer, personal data assistant, pager or another mobile electronic device. The WAP device normally connects via a WAP proxy or gateway 112 to a web server 114. The WAP gateway provides for the ability of a wireless device such as the mobile electronic transaction device 110 to access the Internet using the WAP protocol. The WAP gateway acts as a proxy between a wireless network and a wireline network. The WAP gateway converts between the Wireless Internet based on the WAP protocol and the wireline Internet based on the HTTP protocol.

The web server 114 runs a payment application and in turn interacts with an application server 124. The payment application may be used to facilitate a face-to-face transaction where the merchant or merchant representative and The consumer are together at the same place at the time of the transaction. The payment application may also be used to facilitate a non-face-to-face transaction where the merchant and the consumer are not together at the same place at the time of the transaction. Such a non face-to-face transaction is typical of a consumer making a bill payment for post paid cellular telephone air time for example or for making payments into a prepaid account for cellular air time. This example is also the case where the cellular telephone carrier is not the merchant selling goods and services such as air time, but also where the cellular carrier is is simply enabling other merchants to sell their goods and services to cellular carrier subscribers via pre-pay, post pay or payment aggregation services. The application server includes business logic for processing the various transaction requests from the web server payment application and forwards them to the financial institution (FI). The application server also receives responses from the financial institution and forwards transaction completion notifications and responses to the consumer and to the merchant system via the web server payment application.

As may be seen in FIG. 1, the application server may optionally be coupled via a network to a transaction gateway server (TGS) 118. Such a TGS is described in pending U.S. patent application Ser. No. 09/559,278 incorporated herein by reference. The TGS connects via a proprietary or dedicated network or other similar network to at least one financial transaction server (FTS) or payment gateway 120. In addition, the system 100 may also include an enterprise reporting subsystem (ERS), which is connected to the server 116 for receiving wireless POS transaction information. The ERS also receives information from the clerk or merchant from its POS terminals and possibly the WAP devices.

In general however the specific details of transaction processing are not necessary to an understanding of the present invention and will not be discussed further.

A WAP application 123 is a set of files residing within the payment application 122, which represents the application that has a user interface presented via a number of pages on a WAP enabled device. The application is downloaded to the mobile device as a set of wireless markup language (WML) display pages or cards in a deck, each card or page representing one screen of information. Intermediate calculations such as totaling, tax calculations, coupon calculations are performed within script files, which are also downloaded to the mobile device. Dynamic content needed for the mobile device is generated from a set of Java Servlets and Java Server Pages (JSP) within the web server.

As mentioned earlier during a transactions the user sends a request to the merchant payment application running on the webserver, which in tan forwards the request to a FI for approval. The response from the fl is sent to the payment application, which in rum forwards the response to the user. If for whatever reason the communication between the wireless device and the server breakdown, then an out of balance situation is likely to occur.

The present invention solves this problem by including a sequence number with the messages transmitted during a transaction. In its most basic form the wireless device includes storage for the sequence number. This sequence number is synchronized with the sequence number expected by the business logic contained within the application server. The business logic is responsible for generating, verifying, and storing sequence numbers in a manner to be described below.

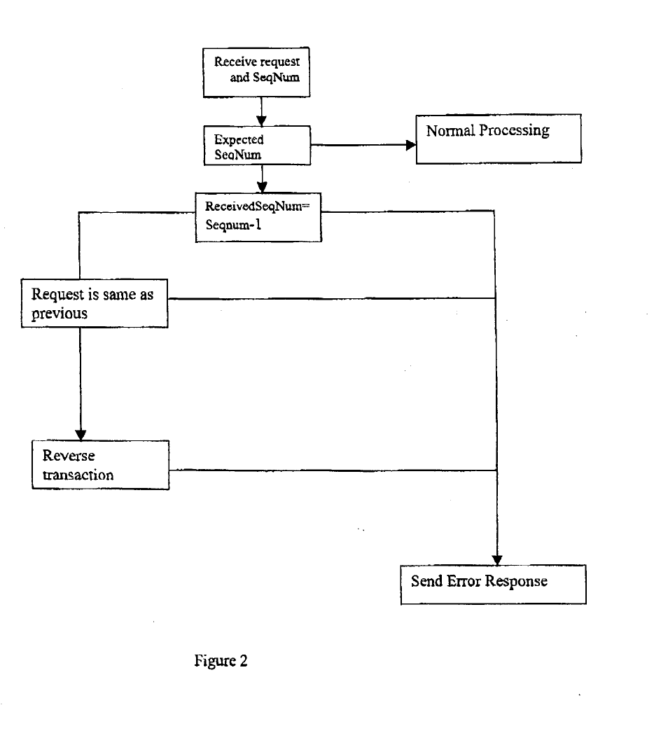

Referring to FIG. 2, there is shown a flow diagram of a general data processing method executed by the business logic at the application server for handling of errors in communication between the wireless device and the payment application server in the wireless transaction processing system. The application server creates, within persistent storage, a transaction log containing recovery information, which can be used for recovery from errors in communication during a transaction.

The manner of using the system 100 may be described as follows. The wireless device 110 sends a transaction request including a prestored sequence number to the application server. For each transaction request received by the application server business logic, the application server processes the request. Once the transaction request has been processed successfully, the transaction is given a status of Pending Persistent Reversal (PPR). This status is necessary, as the application server business logic cannot determine if the mobile device has received its response that the transaction has been processed successfully until the next request is received from the mobile device. The business logic attaches. The next sequence number expected by the mobile device on the outgoing response message. The payment application 122 at the web server keeps this sequence number and includes it as a hidden field on the next set of user interface cards downloaded to the device 110. The next request received from the mobile device can be one of three possibilities: the proper sequence number is sent, the previous sequence number is sent with a duplicate of the previous request, or the previous sequence number is sent with a different request.

The business logic has to wait for the sequence number of the next incoming request from the mobile device. The business logic will either set the status of the previous transaction to completed, or the business logic will reverse the previous transaction. Each of these scenarios is described below in the context of a TGS.

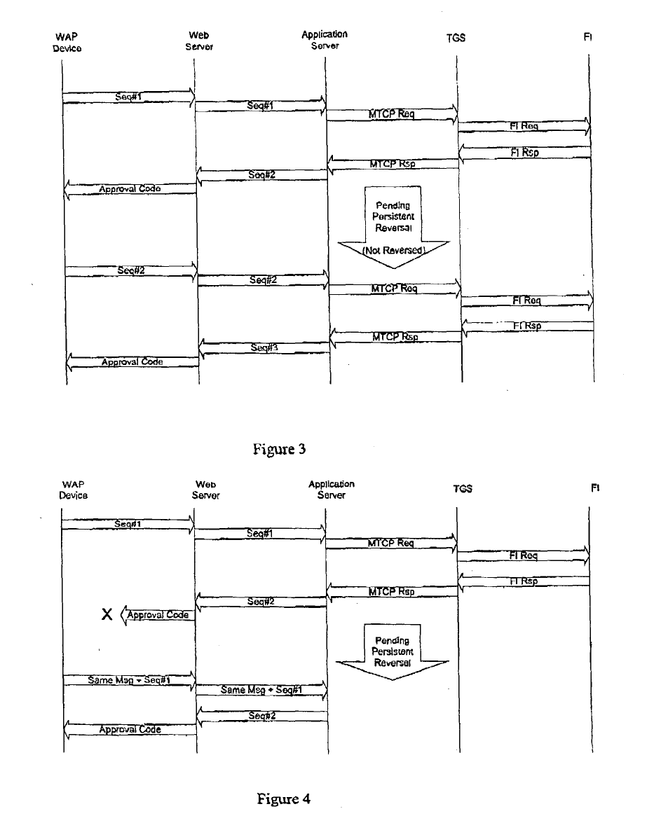

Referring to FIG. 3 there is shown a ladder diagram of an exchange of messages in a transaction system according to an embodiment of the present invention.

1. A request is sent from the WAP device with sequence number 1 and is received by the payment application.

2. The payment application forwards the request with sequence number 1 to the application server business logic.

3. The application server business logic sends the request to the TGS as an MTCP message.

4. The TGS processes the transaction by sending the request to the FI.

5. The FI sends the response to the TGS.

6. The TGS sends the response to the application server business logic in the form of an MTCP response message.

7. The application server business logic determines the next sequence number as 2. The response of the transaction along with the next sequence number is sent to the payment application in the web server.

8. The status of the transaction is set to Pending Persistent Reversal.

9. The response is displayed on the mobile device.

10. Once the user of the mobile device attempts the next transaction, the payment application retrieves the sequence number and sends the next user interface (WML deck) for this transaction along with the sequence number 2 To the mobile device.

11. The user initiates a new transaction which is sent from the device with sequence number 2 to the payment application.

12. The payment application forwards the request with sequence number 2 to the application server business logic.

13. The business logic determines that the request contains the next sequence number and sets the status of the previous transaction to completed and removes the PPR status.

14. The next transaction is processed and steps 3 to 9 are repeated.

Referring to FIG. 4 there is shown a ladder diagram of an exchange of messages in a transaction system, when a message is lost, according to an embodiment of the present invention.

1. A request is sent from the WAP device with sequence number 1 and is received by the payment application.

2. The payment application forwards the request with sequence number 1 to the application server business logic.

3. The application server business logic sends the request to the TGS as an MTCP message.

4. The TGS processes the transaction by sending the request to the FI.

5. The FI sends the response to the TGS.

6. The TGS sends the response to the application server business logic in the form of an MTCP response message.

7. The application server business logic determines the next sequence number as 2. The response of the transaction along with the next sequence number is sent to the payment application in the web server.

8. The status of the transaction is set to Pending Persistent Reversal.

9. The response cannot be displayed on the mobile device, as the message has been lost either on the downlink between the web payment application and the WAP gateway or on the downlink between the WAP gateway and the mobile device.

10. The user does not see the response and attempts to resend the transaction. The transaction request is sent with sequence number 1 to the payment application.

11. The payment application forwards the request with sequence number 1 to the application server business logic.

12. The business logic determines an identical request has been received. Since the business logic stores the response of the previous transaction, the response is sent back to the payment application with sequence number 2.

13. The mobile device receives the response.

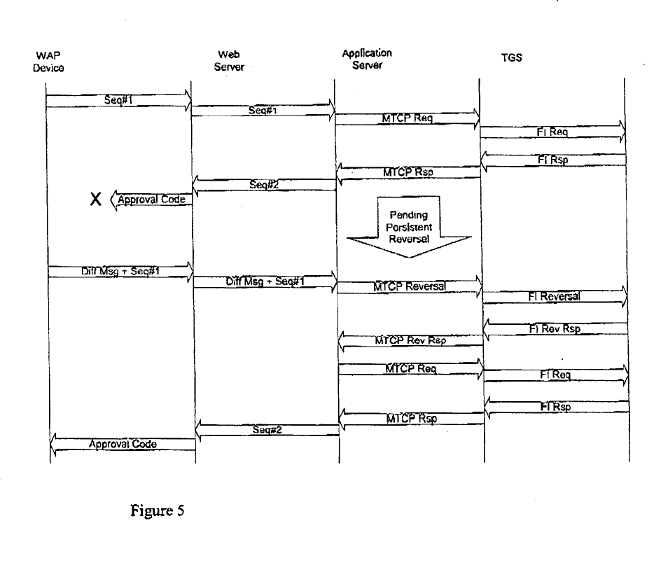

Referring to FIG. 5 there is shown a ladder diagram of an exchange of messages in a transaction system according to an embodiment of the present invention.

1. A request is sent from the WAP device with sequence number 1 and is received by the payment application.

2. The payment application forwards the request with sequence number 1 to the application server business logic.

3. The application server business logic sends the request to the TGS as an MTCP message.

4. The TGS processes the transaction by sending the request to the FI.

5. The FI sends the response to the TGS.

6. The TGS sends the response to the application server business logic in the form of an MTCP response message.

7. The application server business logic determines the next sequence number as 2. The response of the transaction along with the next sequence number is sent to the payment application in the web server.

8. The status of the transaction is set to Pending Persistent Reversal.

9. The response cannot be displayed on the mobile device, as the message has been lost either on the downlink between the web payment application and the WAP gateway or on the downlink between the WAP gateway and the mobile device.

10. The user does not see the response and attempts to resend the transaction. However, the user chooses to change some of the fields before resubmitting the request. The modified transaction request is sent with sequence number 1 to the payment application.

11. The payment application forwards the request with sequence number 1 to the application server business logic.

12. The business logic determines a different transaction has been received with sequence number 1. In this case, the business logic determines that previous transaction has been lost and attempts to perform a reversal on the previous transaction.

13. Once the reversal request has been processed successfully, the application server business logic sends the modified transaction request to the TGS as an MTCP message.

14. The TGS processes the transaction by sending the request to the FI.

15. The FI sends the response to the TGS.

16. The TGS sends the response to the application server business logic in the form of an MTCP response message.

17. The application server business logic determines the next sequence number as 2. The response of the transaction along with the next sequence number is sent to the payment application in the web tier.

18. The status of the transaction is set to Pending Persistent Reversal.

19. The response is displayed on the mobile device,

Accordingly, it may be seen that the present invention provides an efficient solution to the problem of extending a server-side state machine to stateless micro-browser bad devices. While the invention has been described in connection with a specific embodiment thereof and in a specific use, various modifications thereof will occur to those skilled in the art without departing from the spirit of the invention.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the invention.

The embodiments of the invention in which an exclusive property or privilege is claimed are defined as follows:

1. A data processing method for handling of errors in communication between a wireless device and a server in a wireless transaction processing system, the method comprising the steps of:
(a) creating, within persistent storage, a transaction log containing recovery information which can be used for recovery from errors in communication during a transaction;
(b) determining whether error correction information received from said wireless meets at least one predetermined criterion; and
(c) performing an error handling process if the received error correction information meets the predetermined criterion.

2. A data processing method as defined in claim 1, said error correction information being a sequence number.

3. A data processing method as defined in claim 2, said transaction log including transaction identification information and previous sequence numbers.

4. A data processing method as defined in claim 1, including generating a new sequence number.
